(19) United States
(12) Patent Application Publication
(10) Pub. No.: US 2004/0101144 A1
(43) Pub. Date: May 27, 2004

(54) Sound card, computer system using the sound card and control method thereof

(75) Inventor: Man-hee Lee, Suwon City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/686,669

(22) Filed: Oct. 17, 2003

(30) Foreign Application Priority Data
Nov. 21, 2002 (KR) 2002-72845

(51) Int. Cl. H04R 29/00; G06F 17/00

(52) U.S. Cl. 381/58; 700/94

(57) ABSTRACT

A computer system having at least one connection port to which an audio apparatus is connected and a plurality of audio circuit parts operating according to a type of the audio apparatus. The type of the audio apparatus can be selected to connect an audio circuit part, which cooperates with the selected audio apparatus type and one of the connection ports to each other. A sound card functions even though an audio apparatus is connected to any one of the sound card connection ports.

### CROSS-REFERENCE TO RELATED APPLICATIONS

This application claims the benefit of Korean Application No. 2002-72845, filed Nov. 21, 2002, in the Korean Intellectual Property Office, the disclosure of which is incorporated herein by reference.

### BACKGROUND OF THE INVENTION

1. Field of the Invention

The present invention relates to a sound card, a computer system using the sound card and a control method thereof, and more particularly, to a sound card to perform its function even though an audio apparatus is connected to any one of connection ports, a computer system using the sound card and a control method thereof.

2. Description of the Related Art

Functions of a computer system have been varied/expanded because of multimedia implementations in the computer system. Accordingly, the recent computer system has various functions not only to play multimedia, such as a sound, a graphic and a moving picture, but also to implement an Internet phone via the Internet and to process audio through a CD drive. According to a multimedia environment of the computer system, the computer system is generally provided with a sound card to control input/output of a sound.

FIG. 1 is a control block diagram of a conventional sound card. As shown in FIG. 1, the conventional sound card 100 is provided with a speaker connection port 142 to be connected to a speaker 182 or a head set 180, a microphone connection port 144 to be connected to a microphone 184, and a line input connection port 146 to be connected to an external sound apparatus, such as a CD player 186.

Also, the sound card 100 is provided with an audio I/O controller 120 to control an input/output audio signal. The audio I/O control part 120 comprises an output audio circuit part 122 connected to the speaker connection port 142 and processing an audio signal output to the speaker 182 or the head set 180 connected to the speaker connection port 142; an input audio circuit part 124 connected to the microphone connection port 144 and processing an audio signal received from the microphone 184 connected to the microphone connection port 144; and a line input audio circuit part 126 connected to the line input connection port 146 and processing a line input signal.

The sound card 100 is generally provided as a separate PCB (Printed Circuit Board) and mounted in the computer system, but recently is provided in a main system board of the computer system as one body. Generally, a sound card provided in the main system board is called an On-Board type sound card.

In the conventional sound card 100, the output audio circuit part 122, the input audio circuit part 124 and the line input audio circuit part 126 are fixed and connected respectively to the speaker connection port 142, the microphone connection port 144 and the line input connection port 146. Also, connection standards of the respective connection ports 142, 144 and 146 are the same. However, in the case that a user connects a jack of the microphone 184 to the speaker connection port 142, the microphone 184 does not electrically cooperate with the output audio circuit part 122 connected to the speaker connection port 142, and thus, does not work.

Particularly, the connection ports 142, 144 and 146 are generally exposed outward from a rear of a main body of the computer system, so that a user has difficulty in accurately connecting a jack of an audio apparatus to a corresponding/correct connection port 142,144, or 146.

### SUMMARY OF THE INVENTION

Accordingly, the present invention provides a sound card to perform its function even though an audio apparatus, such as a speaker, microphone, etc., is connected to any one of the sound card connection ports, a computer system using the sound card and a control method thereof.

Additional aspects and advantages of the invention will be set forth in part in the description which follows and, in part, will be obvious from the description, or may be learned by practice of the invention.

The present invention may be achieved by a control method of a computer system having at least one connection port to which an audio apparatus is connected and a plurality of audio circuit parts cooperating according to a type of the connected audio apparatus, comprising selecting the type of the audio apparatus, and connecting an audio circuit part capable of cooperating (compatible) with the selected type of the audio apparatus, from among the plurality of the audio circuit parts, to one of the connection ports to be connected to the selected audio apparatus.

According to an aspect of the invention, the selecting is performed by a type selection program based on an operating system to select the type of the audio apparatus.

According to an aspect of the invention, the selecting of the type of the audio apparatus comprises displaying on a monitor a user selection window for selecting the type of the audio apparatus.

According to an aspect of the present invention, the control method further comprises detecting that the audio apparatus is connected to the connection port, wherein the user selection window is activated on the monitor in a case that connection of the audio apparatus to the connection port is detected.

The present invention may also be achieved by providing a computer system comprising at least one connection port to which an audio apparatus is connected; a plurality of audio circuit parts operating according to a type of the audio apparatus; and a control part controlling the connection port to be selectively connected to one of the plurality of the audio circuits.

According to an aspect of the present invention, the control part is operated by a type selection program based on an operating system.

According to an aspect of the present invention, the computer system further comprises a switching part controlled by the type selection program and provided to be selectively connected to the plurality of the audio circuit parts, and thus connecting the at least one connection port and one of the audio circuit parts to each other.

According to an aspect of the invention, the type selection program activates a user selection window for selecting the type of the audio apparatus on a monitor.

According to an aspect of the invention, the type selection program activates the user selection window for selecting the type of the audio apparatus on the monitor in a case that the audio apparatus is connected to the connection port.

According to an aspect of the invention, the user selection window is a port display window to display whether the audio apparatus is connected to a corresponding connection port.

According to an aspect of the invention, the port display window provides an audio apparatus type selection button (menu) for each displayed connection port, and the type selection program controls the switching part so that in a case that the audio apparatus type selection button for a displayed connection port is clicked, the connection port corresponding to the displayed connection port with the clicked audio apparatus type selection button is activated by connecting the audio circuit part corresponding to the clicked audio apparatus type selection button with the corresponding connection port.

The present invention may be also achieved by providing a sound card mounted on a computer system to input/output a sound, comprising at least one connection port to which an audio apparatus is connected; a plurality of audio circuit parts operating according to a type of the audio apparatus; and a switching part provided to be selectively connected to the plurality of the audio circuit parts and connecting the at least one connection port and one of the audio circuit parts to each other.

According to an aspect of the present invention, the switching part is controlled by a type selection program stored in the computer system and operating based on an operating system of the computer system.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a control block diagram of a conventional sound card;

FIG. 2 is a control block diagram of a sound card, according to an embodiment of the present invention;

FIGS. 3A through 3D are views illustrating operation states of a user selection window, according to an embodiment of the present invention; and

FIG. 4 is a control flow diagram of the computer system shown in FIG. 1, according to an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

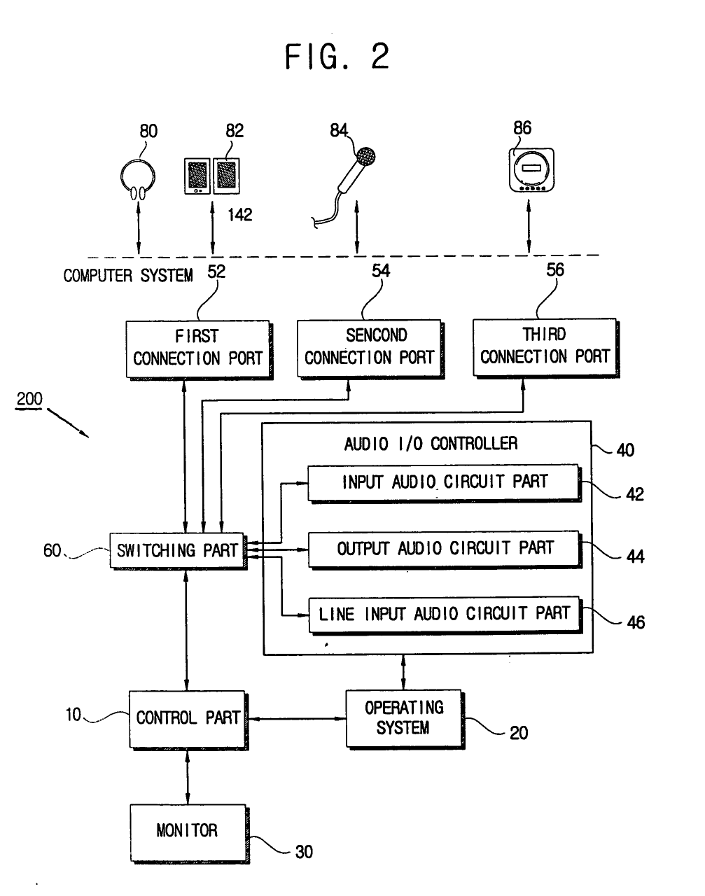

FIG. 2 is a control block diagram of a sound card, according to an embodiment of the present invention. As shown in FIG. 2, the sound card 200, as implemented in a computer system, comprises connection ports 52, 54 and 56 to which an audio apparatus can be connected; an audio I/O controller 40 having a plurality of audio circuit parts 42, 44 and 46 processing an audio signal input/output to/from the computer system and, typically, each audio circuit part 42, 44, and 46 corresponding to a type of the audio apparatus; and a control part 10 to control the connection ports 52, 54 and 56 to be selectively connected to one of the plurality of the audio circuit parts 42, 44 and 46.

Typically, the connection ports 52, 54 and 56 have a same connection standard. For example, each connection port 52, 54 and 56 can receive jacks of the audio apparatuses, such as a speaker 82, a head set 80, a microphone 84, and a CD player 86. The output audio circuit part 44 processes an audio signal output to an audio device outside of the computer system. The input audio circuit part 42 processes an audio signal received from an audio device outside of the computer system. The line input audio circuit part 46 processes a line input signal. The output audio circuit part 44 electrically cooperates with the audio apparatus, such as the speaker 82 or the head set 80, to output an audio signal. The input audio circuit part 42 electrically cooperates with the audio apparatus, such as the microphone 84, to receive and input an audio signal to the computer system. The line input audio circuit part 46 electrically cooperates with the audio apparatus, such as the CD player 86.

The computer system further comprises a switching part 60 controlled by the control part 10, and selectively connectable to the audio circuit parts 42, 44 and 46 and to the connection ports 52, 54 and 56. Therefore, the control part 10 controls the switching part 60 to selectively connect each connection port 52, 54 and 56 to one of the corresponding compatible input, output and line input audio circuit parts 42, 44 and 46. Thus, for example, even though each audio apparatus such as the speaker 82, the microphone 84 or the CD player 86 is connected to the first connection port 52, the sound card 200 is controlled so that each connected audio apparatus is connected to the corresponding compatible audio circuit part 42, 44 or 46. Thus, any of the audio apparatuses can work even though a user connects the audio apparatuses to any one of the connection ports 52, 54 and 56 independent of the types of the audio apparatuses.

Typically, the control part 10 is performed by a type selection program based on an operating system 20 (i.e., an application program interfacing with a user). The type selection program, as an application program executed on the basis of the operating system 20, controls the switching part 60 so that the connection ports 52, 54 and 56 are selectively connected to one of the plurality of the audio circuit parts 42, 44 and 46 according to a user selected audio apparatus type. According to an aspect of the invention, the operating system 20 can execute the type selection program on booting of the computer system, to thereby enable a user to use the type selection program (to be described later) without a separate executing action.

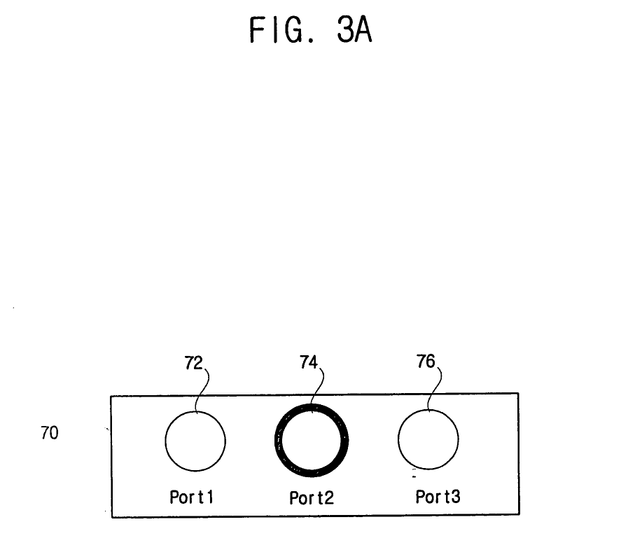

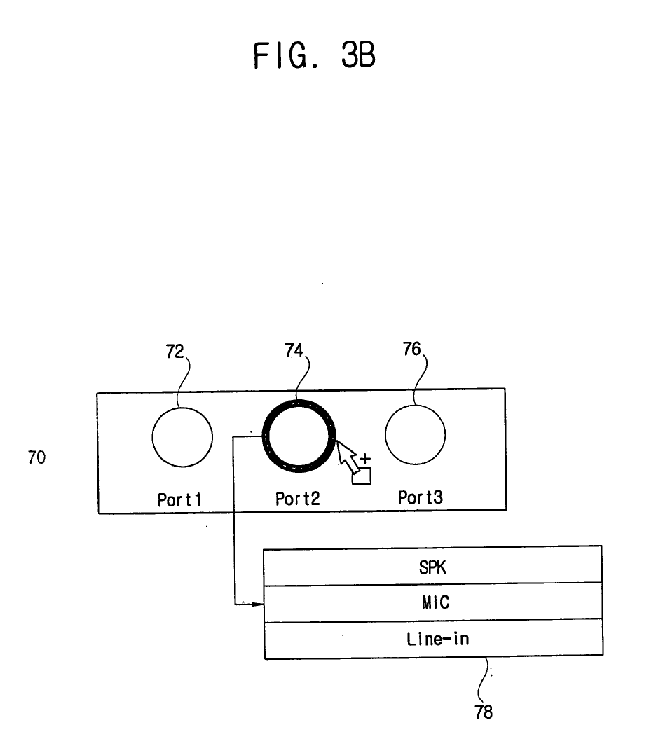

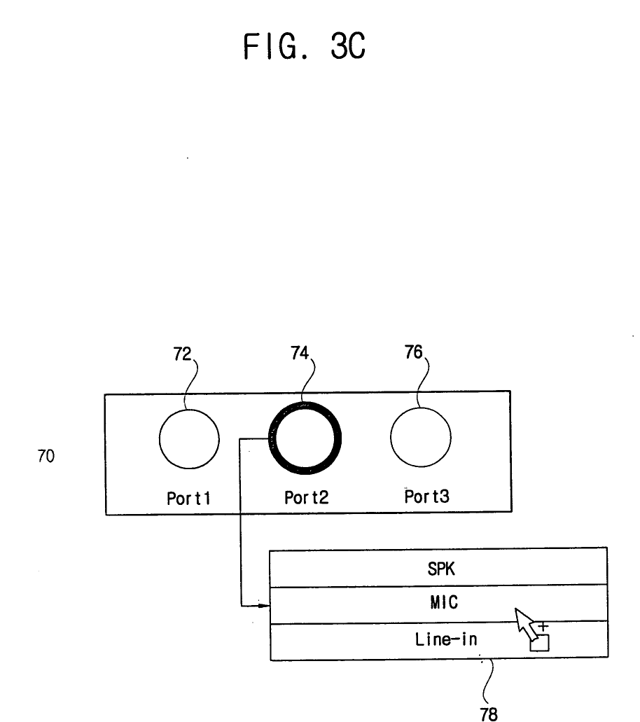

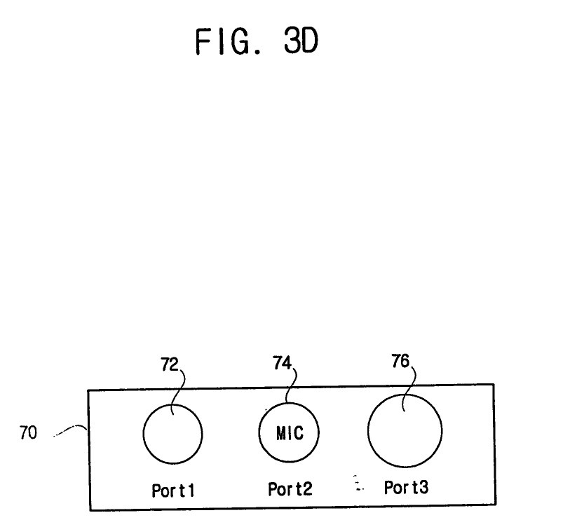

As shown in FIGS. 3A through 3D, the type selection program activates (displays) a user selection window 70 for selecting the type of the audio apparatus on a monitor 30 of the computer system. As shown in FIGS. 3A through 3D, in the user selection window 70 are displayed a first, a second and a third port display window (connection port image) 72, 74 and 76, respectively corresponding to the first, the second and the third connection ports 52, 54 and 56. Each port display window 72, 74 and 76 displays whether the audio apparatus is connected to each connection port 52, 54 and 56 in various methods, such as color change and/or flicker of colors, to enable identification of connected connection ports 52, 54 and 56 (i.e., to inform a user of a connection status of each connection port 52, 54 and 56). The displayed connection status of the audio apparatuses on the port display windows 72, 74 and 76 is also implemented by the type selection program.

As shown in FIG. 3B, also, the type selection program displays an audio apparatus type selection button (menu) 78 for each port display window 72, 74 and 76. For example, in the case that a cursor controlled by mouse operation is brought to the port display window 72, 74 or 76, the type selection program recognizes movement of the cursor, and thus controls the audio apparatus type selection button 78 to be displayed for the port display window 72, 74 or 76 where the cursor is positioned. The audio apparatus type selection button 78 comprises a plurality of selection buttons according to the types of the audio apparatuses. For example, FIGS. 3B and 3C illustrate “SPK”, “MIC” and “Line-in” as the selection buttons of the audio apparatus type selection button 78 for the connection port image “Port 2.” According to an aspect of the present invention, as shown in FIG. 3D, the port display windows 72, 74 and 76 display (i.e., indicate) the audio apparatus type connected, or to be connected, to the connection ports 52, 54 and 56. Typically, the audio apparatus type is displayed on the port display windows 72, 74 and 76 after selection of the audio apparatus type in the audio apparatus type selection button 78.

According to an aspect of the invention, in the case that the audio apparatus is connected to one of the connection ports 52, 54 and 56, the type selection program automatically activates the user display window 70 in the monitor 30. For example, in the case that an audio apparatus is connected to the second connection port 54, the audio I/O controller 40 recognizes the connection of the audio apparatus to the second connection port 54. If the connection of the audio apparatus is recognized by the audio I/O controller 40, the operating system 20 runs the type selection program. The type selection program activates the user selection window 70 on the monitor 30. At this point, the connection of the audio apparatus is displayed in a second port display window 74 of the user selection window 70 (as shown in FIGS. 3A-3D).

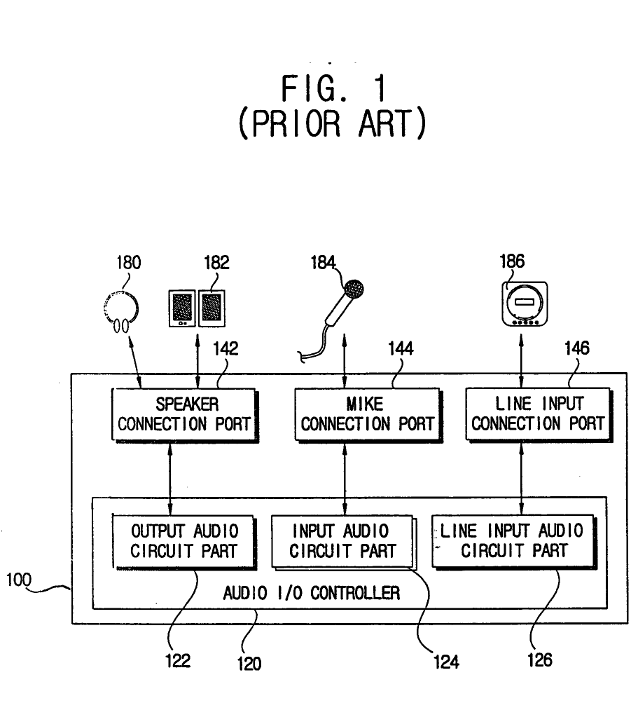

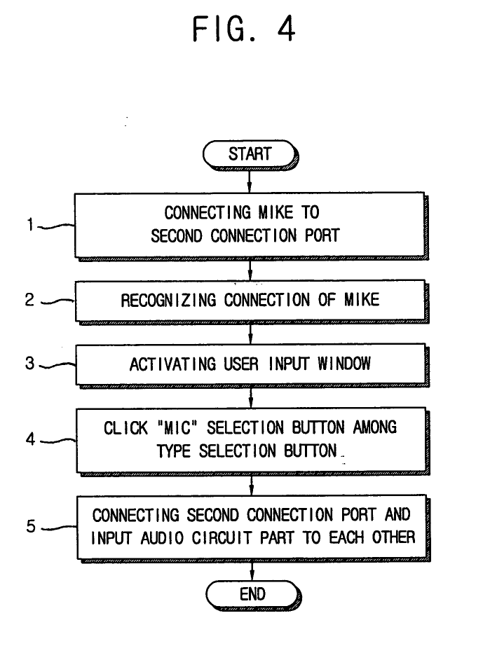

With the above configuration, a control process of the computer system shown in FIG. 1 will be described with reference to FIGS. 3A through 3D and 4, according to an embodiment of the present invention. At operation 1, a user connects the audio apparatus, for example, the microphone 84, to the second connection port 54. At operation 2, the audio I/O controller 40 recognizes connection of the microphone 84 and transmits connection information to the operating system 20. At operation 3, the operating system 20 runs the type selection program, and the executed type selection program activates the user selection window 70 on the monitor 30. In this case, as shown in FIG. 3A, the connection of the audio apparatus is displayed by, for example, bolding a color of the second port display window 74 of the activated user selection window 70, thereby providing a connection port status.

Thereafter, at operation 4, when the user clicks the second port display window 74 displayed on the monitor 30 by using the mouse, the audio apparatus type selection button 78 is activated in the second port display window 74 (refer to FIG. 3B). Subsequently, if, at operation 4, the user clicks the “MIC” button, at operation 5, the type selection program controls the switching part 60 so that the second connection port 54 corresponding to the second port display window 74 and the input audio circuit part 42 corresponding to the “MIC” button in the audio apparatus type selection buttons 78 are connected to each other. Further, if the user clicks the “MIC” selection button in the audio apparatus type selection button 78 of the second port display window 74, as shown in FIG. 3D, the audio apparatus type “MIC” is displayed on the second port display window 74 indicating that the second connection port 54 and the input audio circuit part 42 are connected to each other. Also, the first and the third port display windows 72 and 76 work the same way as the described second port display window 74. The “SPK” button and the “Line-in” button in the audio apparatus type selection button 78 (FIGS. 3B, 3C) correspond, respectively, to the output audio circuit part 44 and the line input audio circuit part 46.

According to the present invention, the connection ports 52, 54 and 56, the switching part 60, and the audio circuit parts 42, 44 and 46 can be provided on a separate sound card to be mounted on the computer system. Also, the switching part 60 and the audio circuit parts 42, 44 and 46 can be mounted on a main system board and the connection ports 52, 54 and 56 can be exposed outward of the computer system by a separate cable. Also, although in the above described embodiment, only three connection ports 52, 54 and 56 are provided, the present invention is not limited to such a configuration, and additional connection ports may be provided.

According to the present invention, a sound card performs its function even though an audio apparatus is connected to any one of connection ports by providing a plurality of audio circuit parts operating according to a type of the audio apparatus and a control part controlling each connection port to be selectively connected to a compatible one of the plurality of the audio circuit parts. Further, the present invention relates to a computer system having at least one connection port to which an audio apparatus is connected and a plurality of audio circuit parts operating according to a type of the audio apparatus. The type of the audio apparatus can be selected to connect an audio circuit part, which cooperates with the selected audio apparatus type, and one of the connection ports to each other. A sound card functions even though an audio apparatus is connected to any one of the sound card connection ports.

Although the present invention as described in the above embodiments is applied to a computer sound card, the present invention may not be limited to such a configuration and can be applied to any computer multimedia environment implementations, such as a video, video/audio, game, etc. card/on board type system component, in which the computer multimedia component has two or more same standard connection ports to which interchangeably various types of external multimedia apparatuses can be connected. Accordingly, the present invention provides a computer multimedia component dynamically selectively connecting a connection port connected to a type of external multimedia apparatus with an information signal processing unit in the multimedia component that is compatible with the type of the connected external multimedia apparatus, thereby allowing any external multimedia apparatus type to be connected via any of the same standard connection ports of the multimedia component. Further the present invention provides a machine-readable storage storing at least one program controlling a multimedia component of a computer system according to a process of displaying a connection port selection window, allowing user selection of a multimedia apparatus type corresponding to a connection port and controlling the multimedia component to connect a connection port to a compatible information signal processor according to the selection. The processes of the present invention as shown in FIG. 4 are embodied in computing hardware and/or software.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A control method of a computer system having at least one connection port to which an audio apparatus is connected and a plurality of audio circuit parts operating according to a type of the audio apparatus, comprising:
selecting the type of the audio apparatus;
connecting an audio circuit part cooperable with the selected audio apparatus type from among the plurality of the audio circuit parts and one of the connection ports to each other.

2. The control method of the computer system according to claim 1, wherein the selecting is performed by a type selection program based on an operating system to select the type of the audio apparatus.

3. The control method of the computer system according to claim 1, wherein the selecting of the type of the audio apparatus comprises displaying a user selection window for selecting the type of the audio apparatus on a computer system monitor.

4. The control method of the computer system according to claim 3, further comprising detecting that the audio apparatus is connected to the connection port, wherein the user selection window is displayed on the monitor according to the detecting.

5. A computer system comprising:
at least one connection port to which an audio apparatus is connected;
a plurality of audio circuit parts operating according to a type of the audio apparatus; and
a control part controlling selective connection of the at least one connection port to one of the plurality of the audio circuits operable with the audio apparatus type connected to the at least one connection port.

6. The computer system according to claim 5, wherein the control part is a machine-readable storage storing a type selection program based on an operating system.

7. The computer system according to claim 6, further comprising a switching part controlled by the type selection program to selectively connect the plurality of the audio circuit parts and the at least one connection port to each other.

8. The computer system according to claim 7, wherein the type selection program displays a user selection window for selecting the type of the audio apparatus on a monitor.

9. The computer system according to claim 8, wherein the type selection program displays the user selection window for selecting the type of the audio apparatus on the monitor, upon connection of the audio apparatus to the connection port.

10. The computer system according to claim 9, wherein in the user selection window is a connection port display window to display whether the audio apparatus is connected to a corresponding connection port via each displayed connection port.

11. The computer system according to claim 10, wherein the port display window provides an audio apparatus type selection button for each displayed connection port, and the type selection program controls the switching part so that if the audio apparatus type selection button is selected for a displayed connection port, the connection port corresponding to the displayed connection port with the selected audio apparatus type selection button is activated by connecting the audio circuit part corresponding to the selected audio apparatus type selection button with the corresponding connection port.

12. A sound card mounted on a computer system and inputting/outputting a sound, comprising:
at least one connection port to which an audio apparatus is connected;
a plurality of audio circuit parts operating according to a type of the audio apparatus; and
a switching part selectively connecting the at least one connection port to one of the plurality of the audio circuit parts operable with the audio apparatus type connected to the at least one connection port.

13. The sound card according to claim 12, wherein the switching part selectively connects according to a type selection program executing in the computer system.

14. A computer sound card, comprising:
two or more connection ports to which audio apparatuses are connected; and
an audio signal processor processing input and/or output audio signals from/to the audio apparatuses connected to any one of the connection ports independent of a type of each audio apparatus.

15. The computer sound card of claim 14, wherein the audio signal processor comprises:
at least one audio circuit compatible with the type of the audio apparatus; and
a controllable controller selectively connecting each connection port to the audio circuit parts compatible with the audio apparatus type connected to each connection port.

16. A machine-readable storage storing at least one program controlling a multimedia component of a computer system according to a process comprising:
displaying a connection port selection window;
selecting a multimedia apparatus type for the connection port; and
controlling the multimedia component to connect the connection port to a compatible information signal processor of the multimedia component according to the selection.

17. The machine-readable storage of claim 16, wherein the displaying of the connection port window comprises displaying connection port images corresponding to connection ports of the multimedia component.

18. A computer system, comprising:
a multimedia component having two or more same standard connection ports; and
a programmed computer processor detecting connection of a multimedia apparatus to one of the connection ports, displaying a graphical user interface comprising connection port images corresponding to the connection ports of the multimedia component, activating multimedia apparatus type selection menus for each connection port image, and controlling the multimedia component to connect the one connection port connected to the detected multimedia apparatus to a compatible information signal processor of the multimedia component according to a multimedia apparatus type selection in the activated multimedia apparatus type selection menu for the one connection port.
